(19) United States
(12) Patent Application Publication
(10) Pub. No.: US 2023/0086285 A1
(43) Pub. Date: Mar. 23, 2023

(54) INFORMATION PROCESSING APPARATUS, INFORMATION PROCESSING METHOD, AND RECORDING MEDIUM

(71) Applicant: NEC Corporation, Tokyo (JP)

(72) Inventors: Fumiyuki MIYAHARA, Tokyo (JP); Takahisa Watanabe, Tokyo (JP)

(73) Assignee: NEC Corporation, Tokyo (JP)

(21) Appl. No.: 17/902,289

(22) Filed: Sep. 2, 2022

(30) Foreign Application Priority Data
Sep. 22, 2021 (JP) 2021-154413

(51) Int. Cl. G09B 5/12; G06K 9/62; G06F 16/906

(52) U.S. Cl. CPC G09B 5/12; G06K 9/6267; G06F 16/906

(57) ABSTRACT

Provided is a mechanism for facilitating a teacher to review an online class content and how to proceed with the class. A collection unit collects log information from a user terminal, a classification unit classifies a class content, based on the log information, an extraction unit extracts information indicating a used content from the log information of the user terminal, and a recording unit records the information indicating a classification of the class and the information regarding the contents.

This application is based upon and claims the benefit of priority from Japanese Patent Application No. 2021-154413, filed on Sep. 22, 2021, the disclosure of which is incorporated herein in its entirety by reference.

### TECHNICAL FIELD

The present invention relates to an information processing apparatus, an information processing method, and a program, and more particularly, to an information processing apparatus, an information processing method, and a program that process log information or the like acquired from a user terminal.

### BACKGROUND ART

In general learning instruction in a school, a teacher prepares, after each class, a record of class content and how to proceed with the class (so-called class record) and a report on a progress status of learning for each student (so-called instruction report). When deciding the nest class content, the teacher can accurately remember the previous class content by checking the created record.

In private companies such as cram schools and preparatory schools, more advanced information communication technology (ICT) systems have been adopted.

For example, Patent Document 1 (JP 2005-182272 A1) describes that a management program creates a learning instruction to be given to a lecturer using a management database and a curriculum database, and creates an instruction report including advice to a student on the basis of a learning result of the student. Patent Document 2 (JP 2008-009876 A1) discloses a system that enables each of four persons including a classroom manager, a lecturer, a student, and a guardian to transmit and receive data to and from a management server from a dedicated menu screen.

### SUMMARY

In the future, each student can participate in an online class through a user terminal such as a tablet terminal or a personal computer by utilizing the improved ICT infrastructure. As a result, it is considered that opportunities to use various kinds of content such as digital textbooks and educational applications increase. Therefore, there is a demand for a mechanism for promoting an online class while reducing a burden on a teacher.

The present invention has been made in view of the above problems, and an object of the present invention is to provide a mechanism for facilitating a teacher to review the online class content and how to proceed with the class.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of an information processing apparatus according to Example Embodiment 1 or 2;

FIG. 2 is a flowchart illustrating an operation of the information processing apparatus according to Example Embodiment 1 or 2;

FIG. 3 is an example of a record generated by the information processing apparatus according to Example Embodiment 1 or 2;

FIG. 4 is a diagram illustrating an example of a class content type;

FIG. 5 is a block diagram illustrating a configuration of an information processing apparatus according to Example Embodiment 3;

FIG. 6 is a flowchart illustrating an operation of the information processing apparatus according to Example Embodiment 1 or 2;

FIG. 7 is an example of a report created by the information processing apparatus according to Example Embodiment 3;

FIG. 8 is a diagram schematically illustrating an example of a configuration of a communication system including the information processing apparatus according to any one of Example Embodiments 1 to 3; and

FIG. 9 is a diagram illustrating an example of a hardware configuration of an information processing apparatus according to Example Embodiments 1 to 3.

### EXAMPLE EMBODIMENT

Some example embodiments of the present invention will be described with reference to the drawings.

### Example Embodiment 1

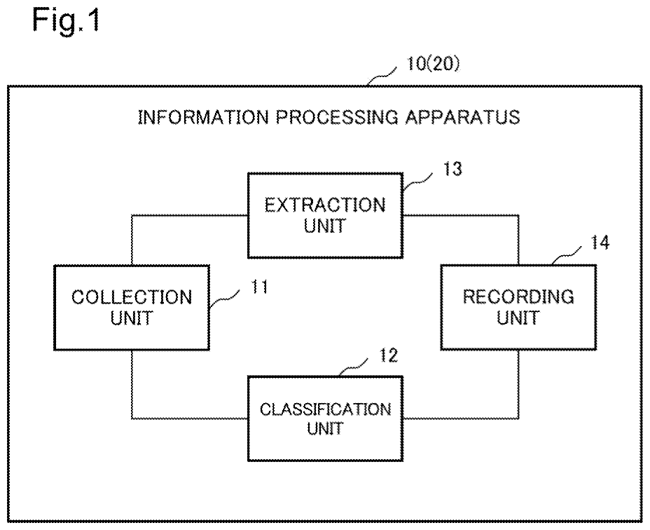

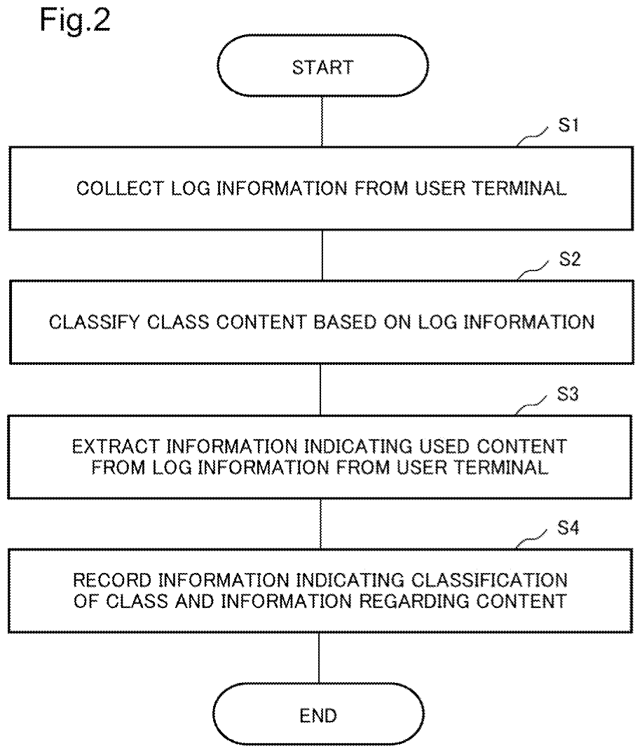

Example Embodiment 1 will be described with reference to FIGS. 1 and 2.

(Information Processing Apparatus 10)

A configuration of an information processing apparatus 10 according to the present Example Embodiment 1 will be described with reference to FIG. 1. FIG. 1 is a block diagram illustrating a configuration of the information processing apparatus 10. As illustrated in FIG. 1, the information processing apparatus 10 includes a collection unit 11, a classification unit 12, an extraction unit 13, and a recording unit 14. Each component of the information processing apparatus 10 will be described below.

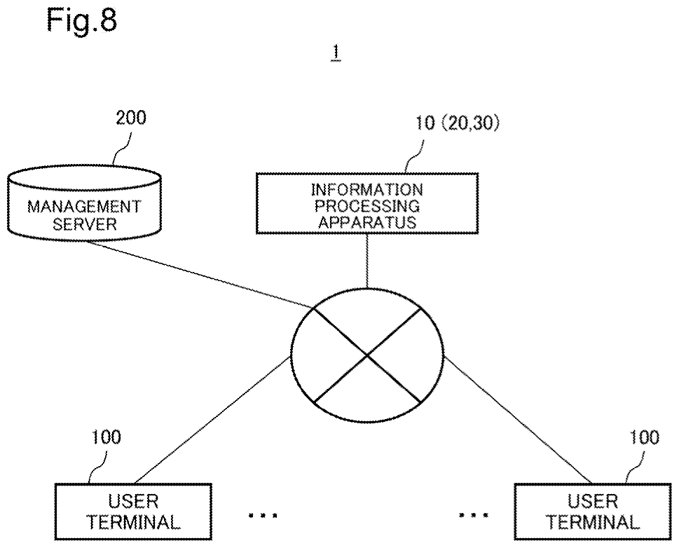

The collection unit 11 collects log information from a user terminal 100 (FIG. 8). The collection unit 11 is an example of a collection means. In one example, the collection unit 11 accesses the user terminal 100 through a certain communication network and transmits the log information to request the user terminal 100. Alternatively, the user terminal 100 may be set in such a way that the log information is periodically transmitted from the user terminal 100 to the information processing apparatus 10. The collection unit 11 collects the log information transmitted from the user terminal 100.

The log information includes information indicating the content used in the user terminal 100. The log information may include at least one of an operation log, an authentication log, an access log, a communication log, a call log, and an event log. The information indicating the content used in the user terminal 100 includes, for example, a uniform resource locator (URL) of an access destination website from the user terminal 100, information indicating a type of an application (including a web application) activated by the user terminal 100, and information indicating a file name attached to a file accessed from the user terminal 100.

Alternatively, the log information of the user terminal 100 may be temporarily stored in the management server 200 (FIG. 8). In this case, instead of collecting the log information from the user terminal 100, the collection unit 11 can indirectly collect the log information transmitted from the user terminal 100 from the management server 200.

The collection unit 11 outputs the log information collected from the user terminal 100 to the classification unit 12 and the extraction unit 13.

The classification unit 12 classifies the class content on the basis of the log information. The classification unit 12 is an example of a classification means. In one example, the classification unit 12 receives the log information collected from the user terminal 100 from the collection unit 11. The classification unit 12 analyzes how the user terminal 100 is used by using the log information.

In the first example, the classification unit 12 extracts keystroke data indicating an operation input amount to the user terminal 100 from the operation log of the log information. The classification unit 12 compares a first operation input amount to the first user terminal 100 used by a teacher with a second operation input amount to the second user terminal 100 used by a student. Then, the classification unit 12 classifies the class content on the basis of the first operation input amount and the second operation input amount. A more detailed specific example will be described in Example Embodiment 2.

In the second example, the collection unit 11 collects an access log (an example of log information) from the user terminal 100. The classification unit 12 receives the access log as log information from the collection unit 11. The classification unit 12 classifies the class content on the basis of one or more of a domain name or a file name included in the URL of the access destination website from the user terminal 100, a page title, an HTML tag (for example, a title tag), and metadata.

In the third example, the collection unit 11 collects an access log (an example of log information) from the user terminal 100. The classification unit 12 receives the access log as log information from the collection unit 11. The classification unit 12 classifies the class content on the basis of one or more of the contents and keywords of a web page specified by the URL of the access destination website from the user terminal 100 or a document, an image, or a moving image linked to the web page.

In the fourth example, the collection unit 11 collects an operation log (an example of log information) from the user terminal 100. The classification unit 12 classifies the class content on the basis of the content of an application (including a web application) activated by the user terminal 100 or a teaching subject related to the application.

The classification unit 12 outputs information indicating the classification of class content to the recording unit 14.

The extraction unit 13 extracts information indicating used content from the log information of the user terminal 100. The extraction unit 13 is an example of an extraction means.

In one example, the extraction unit 13 receives the log information collected from the user terminal 100 from the collection unit 11. The extraction unit 13 extracts information indicating the content used in the user terminal 100 from the log information. For example, the information indicating content includes a URL of a video site or the like, information indicating a type of a web application such as a cloud application, and information indicating a file name attached to an overwritten file.

The extraction unit 13 extracts information indicating the content used in the user terminal 100, and outputs the information to the recording unit 14.

The recording unit 14 records the information indicating the classification of the class and the information regarding the content. The recording unit 14 is an example of a recording means. Hereinafter, a record including the information indicating the classification of the class and the information regarding the content may be simply referred to as a “record”.

In one example, the recording unit 14 receives information indicating the classification of the class content from the classification unit 12. The recording unit 14 receives information indicating the content used in the user terminal 100 from the extraction unit 13. Then, the recording unit 14 records the information indicating the classification of the class and the information regarding the content.

For example, the recording unit 14 transmits the record to the management server 200 (FIG. 8) via the communication network. The record is stored in the management server 200.

As a result, the teacher can easily refer to or acquire the report data stored in the management server 200 by connecting to the network using the user terminal 100.

(Operation of Information Processing Apparatus 10)

An example of the operation of the information processing apparatus 10 according to the present Example Embodiment 1 will be described with reference to FIG. 2. FIG. 2 is a flowchart illustrating a flow of processing executed by each unit of the information processing apparatus 10.

As illustrated in FIG. 2, the collection unit 11 collects log information from the user terminal 100 (S1). The collection unit 11 outputs the log information collected from the user terminal 100 to the classification unit 12 and the extraction unit 13.

The classification unit 12 receives the log information collected from the user terminal 100 from the collection unit 11. The classification unit 12 classifies the class content on the basis of the log information (S2). The classification unit 12 outputs information indicating the classification of class content to the recording unit 14.

The extraction unit 13 receives the log information collected from the user terminal 100 from the collection unit 11. The extraction unit 13 extracts information indicating the used content from the log information of the user terminal 100 (S3). The extraction unit 13 outputs information indicating the content used in the user terminal 100 to the recording unit 14.

The recording unit 14 receives information indicating the classification of the class content from the classification unit 12. The recording unit 14 receives information indicating the content used in the user terminal 100 from the extraction unit 13. Then, the recording unit 14 records the information indicating the classification of the class and the information regarding the content (S4). For example, the recording unit 14 stores the record in the management server 200 (FIG. 8).

As described above, the operation of the information processing apparatus 10 according to Example Embodiment 1 ends.

### Effects of Present Example Embodiment

According to the configuration of the present example embodiment, the collection unit 11 collects log information from the user terminal 100. The classification unit 12 classifies the class content on the basis of the log information. The extraction unit 13 extracts information indicating used content from the log information of the user terminal 100. The recording unit 14 records the information indicating the classification of the class and the information regarding the content. When deciding the next class content, the teacher can accurately remember the previous class content by checking the record. The teacher can share information on the class content and how to proceed with the class with another teacher. In this way, by providing a mechanism for facilitating the teacher to review the online class content and how to proceed with the class, it is possible to promote the online class while reducing the burden on the teacher.

### Example Embodiment 2

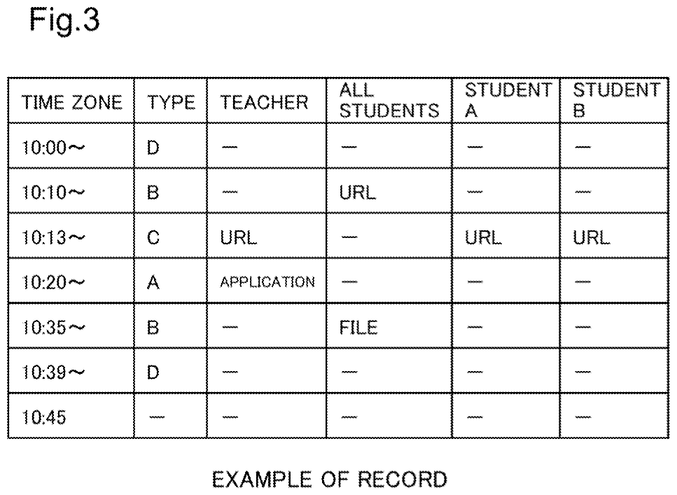

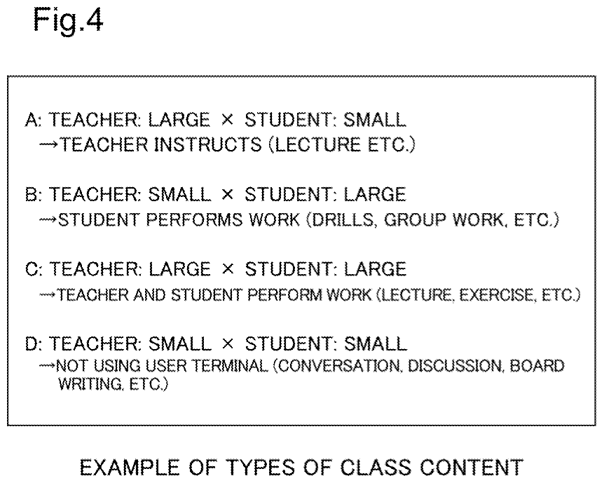

Example Embodiment 2 will be described with reference to FIGS. 3 to 4. In Example Embodiment 2, an example of the recording described in Example Embodiment 1 will be described. Here, the record means a record including information indicating the classification of the class and information regarding content. In Example Embodiment 2, an example of a class content type described in Example Embodiment 1 will be described.

The configuration of an information processing apparatus 20 (FIG. 1) according to Example Embodiment 2 is the same as the configuration of the information processing apparatus 10 according to Example Embodiment 1. In Example Embodiment 2, the description regarding the configuration and operation of the information processing apparatus 10 in Example Embodiment 1 is cited, and the description regarding the common configuration and operation of the information processing apparatus 20 is omitted.

(Example of Record and Class Content Type)

FIG. 3 illustrates an example of a record. The record illustrated in FIG. 3 includes information indicating a time zone in which a class is conducted, information indicating a class content type, and information indicating the content used by the user terminal 100 of each teacher/student.

FIG. 4 illustrates an example of a class content type. FIG. 4 illustrates four different types. That is, the four types are type A, type B, type C, and type D. Type A is, for example, a type in which the number of times the teacher hits the keyboard is relatively large and the number of times the student hits the keyboard is relatively small as in a case where the teacher instructs all the students all at once. For example, Type A includes a lecture from a platform. Type B is, for example, a type in which the number of times the teacher hits the keyboard is relatively small and the number of times the student hits the keyboard is relatively large as in a case where the student performs work individually or as a team. For example, Type B includes a drill and a group work. Type C is, for example, a type in which the number of times the teacher hits the keyboard is relatively large and the number of times the student hits the keyboard is relatively large as in a case where the teacher and the student perform work mutually or simultaneously.

For example, Type C includes a lecture and an exercise. Type D is, for example, a type in which the number of times the teacher hits the keyboard is relatively small and the number of times the student hits the keyboard is relatively small as in a case where both the teacher and the student hardly use the user terminal 100, for example. For example, Type D includes a conference, a discussion, and a board writing.

An example of a method of creating the record illustrated in FIG. 3 will be described. First, the recording unit 14 acquires information indicating class hours. For example, the recording unit 14 acquires data of a class schedule from the management server of the school. Alternatively, the recording unit 14 may receive data of a class schedule from the user terminal 100 of the teacher.

First, the recording unit 14 records information indicating the classification (“D” in FIG. 3) immediately after the start of the class together with information indicating the time when the class started (in FIG. 3, 10:00) on the basis of the information indicating the class content type by the classification unit 12. The recording unit 14 receives, from the extraction unit 13, information indicating the content used by a teacher and a student from the respective user terminals 100. Then, the recording unit 14 records the information indicating the content used by the teacher and the student in association with the information indicating the classification immediately after the start of the class.

Thereafter, the recording unit 14 detects that the type has changed on the basis of the information indicating the class content type by the classification unit 12. Every time the type change is detected, the recording unit 14 records the information indicating the type after the change, the information indicating the time when the type changes, and the information indicating the content used by the teacher and the student.

In this manner, the recording unit 14 adds the row of the record illustrated in FIG. 3 each time the class content type changes within the time of one class.

For example, attention is paid to the second row of the recording illustrated in FIG. 3. It is written therein that a class is started from 10:00 and a class content type is “D” in a time zone from 10:10. Referring to FIG. 4, the class content type being “D” indicates that both the teacher and the student are conducting the class without using the user terminal 100.

Next, attention is paid to the third row of the recording illustrated in FIG. 3. It is described therein that a class content type has been changed from “D” to “B” at 10:10. In 10:10, all the students access a web page specified by the URL using their respective user terminals 100. On the other hand, the teacher does not use the content by using the user terminal 100 of the teacher.

As described above, the information indicating the classification of the class and the information regarding the used content are recorded every time the class content type is changed. When deciding the next class content, the teacher can accurately remember the previous class content by checking the record exemplified in FIG. 3. For example, in a case where the previous class content is only a drill “B”, the teacher can try to talk with the students a lot in the next class.

### Effects of Present Example Embodiment

According to the configuration of the present example embodiment, the collection unit 11 collects log information from the user terminal 100. The classification unit 12 classifies the class content on the basis of the log information. The extraction unit 13 extracts information indicating used content from the log information of the user terminal 100. The recording unit 14 records the information indicating the classification of the class and the information regarding the content. When deciding the next class content, the teacher can accurately remember the previous class content by checking the record. The teacher can share information on the class content and how to proceed with the class with another teacher. In this way, by providing a mechanism for facilitating the teacher to review the online class content and how to proceed with the class, it is possible to promote the online class while reducing the burden on the teacher.

### Example Embodiment 3

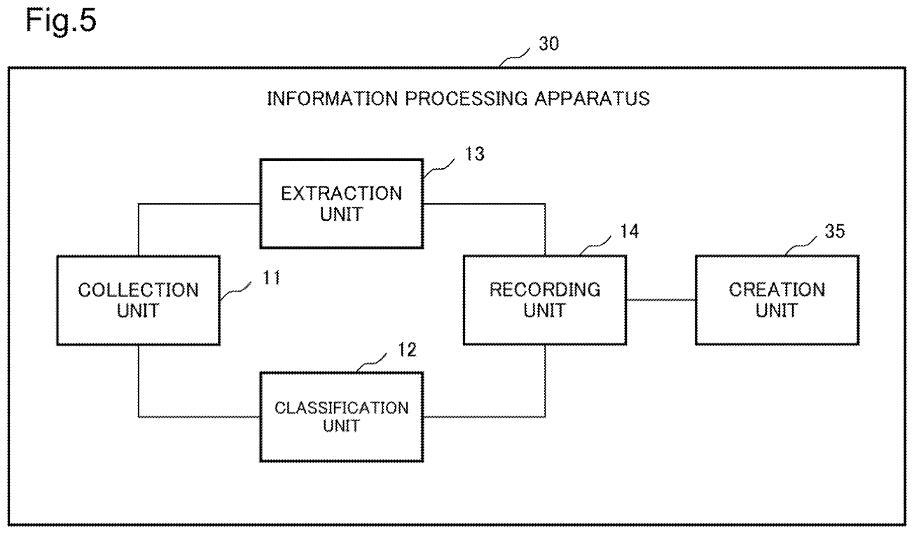

Example Embodiment 3 will be described with reference to FIGS. 5 to 7. In Example Embodiment 3, a configuration for creating a report on the progress status of learning guidance will be described. In Example Embodiment 3, regarding the components common to Example Embodiment 1 or Example Embodiment 2, the description in Example Embodiment 1 or Example Embodiment 2 is cited, and the description thereof will be omitted. Hereinafter, the report on the progress status of the learning guidance is simply referred to as a report.

(Information Processing Apparatus 30)

A configuration of an information processing apparatus 30 according to the present Example Embodiment 3 will be described with reference to FIG. 5. FIG. 5 is a block diagram illustrating a configuration of the information processing apparatus 30. As illustrated in FIG. 5, the information processing apparatus 30 includes a collection unit 11, a classification unit 12, an extraction unit 13, and a recording unit 14. The information processing apparatus 20 further includes a creation unit 35.

The creation unit 35 creates a report including information indicating the classification of the class and information regarding content. The creation unit 35 is an example of a creation means.

In one example, the creation unit 35 acquires the information indicating the classification of the class generated by the classification unit 12 from the recording unit 14. The creation unit 35 also acquires information regarding the content used in the user terminal 100 from the recording unit 14. The creation unit 35 creates a report to be submitted to an education-related institution or an education-related person on the basis of the information indicating the classification of the class and the information regarding the used content.

Alternatively, the creation unit 35 may acquire log information of the user terminal 100 instead of the information regarding the used content. For example, the creation unit 35 receives the log information collected from the user terminal 100 from the collection unit 11. In this case, the creation unit 35 creates the above-described report on the basis of the information indicating the classification of the class and the log information from the user terminal 100. An example of the report created by the creation unit 35 will be described later.

The creation unit 35 may transmit the created report to the management server 200. As a result, the education-related institution or the education-related person can confirm the report stored in the management server 200 at any time. In addition, there is an advantage that it is possible for a teacher to omit time and effort for creating a report.

(Operation of Information Processing Apparatus 30)

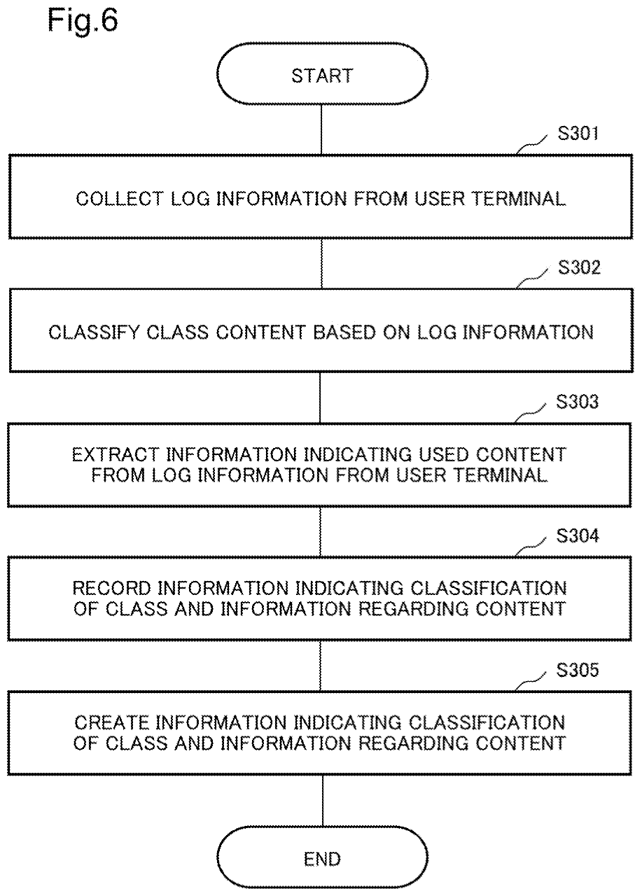

An example of the operation of the information processing apparatus 30 according to the present Example Embodiment 3 will be described with reference to FIG. 6. FIG. 6 is a flowchart illustrating a flow of processing executed by each unit of the information processing apparatus 30.

As illustrated in FIG. 6, the collection unit 11 collects log information from the user terminal 100 (S301). The collection unit 11 outputs the log information collected from the user terminal 100 to the classification unit 12 and the extraction unit 13.

The classification unit 12 receives the log information collected from the user terminal 100 from the collection unit 11. The classification unit 12 classifies the class content on the basis of the log information (S302). The classification unit 12 outputs information indicating the classification of class content to the recording unit 14.

The extraction unit 13 receives the log information collected from the user terminal 100 from the collection unit 11. The extraction unit 13 extracts information indicating used content from the log information of the user terminal 100 (S303). The extraction unit 13 outputs information indicating the content used in the user terminal 100 to the recording unit 14.

The recording unit 14 receives information indicating the classification of the class content from the classification unit 12. The recording unit 14 receives information indicating the content used in the user terminal 100 from the extraction unit 13. Then, the recording unit 14 records the information indicating the classification of the class and the information regarding the content (S304). For example, the recording unit 14 stores the record in the management server 200 (FIG. 8). The recording unit 14 outputs the information indicating the class content and the information indicating the used content to the creation unit 35.

The creation unit 35 receives the information indicating the class content and the information indicating the used content from the recording unit 14. The creation unit 35 creates a report including information indicating the class content and information indicating used content (S305). Thereafter, the creation unit 35 may transmit the created report to the management server 200 (FIG. 8).

As described above, the operation of the information processing apparatus 30 according to the present Example Embodiment 3 ends.

(Example of Report)

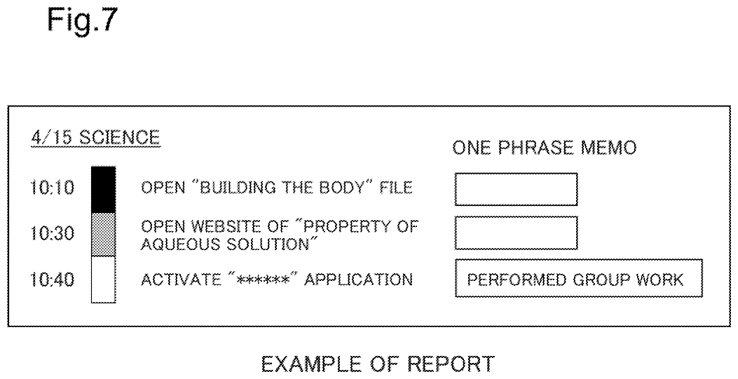

FIG. 7 illustrates an example of a report created by the creation unit 35. In the example illustrated in FIG. 7, a science class conducted on April 16 is described. Specifically, time is described on the left side of the report illustrated in FIG. 7. On the right side thereof, a bar indicating a class content type and a description regarding the content used in the class are described.

For example, in the row of 10:10, “open the ‘Building the body’ file” is performed in the user terminal 100. In the following row of 10:30, “open a website of “property of aqueous solution” is performed in the user terminal 100. In this manner, it is possible to read what the teacher or the student who uses the user terminal 100 did during class from the report illustrated in FIG. 7.

In the row of 10:40, one phrase memo “performed group work” is attached in addition to the description of “activate '******” application”. In the column of one phrase memo, for example, impressions of the class by the teacher and personal supplements are described. Only the teacher can edit the content of the one-phrase memo in the report illustrated in FIG. 7 using the user terminal 100.

### Effects of Present Example Embodiment

According to the configuration of the present example embodiment, the collection unit 11 collects log information from the user terminal 100. The classification unit 12 classifies the class content on the basis of the log information. The extraction unit 13 extracts information indicating used content from the log information of the user terminal 100. The recording unit 14 records the information indicating the classification of the class and the information regarding the content. When deciding the next class content, the teacher can accurately remember the previous class content by checking the record. The teacher can share information on the class content and how to proceed with the class with another teacher. In this way, by providing a mechanism for facilitating the teacher to review the online class content and how to proceed with the class, it is possible to promote the online class while reducing the burden on the teacher. Further, according to the configuration of the present example embodiment, the creation unit 35 creates the report including the information indicating the classification of the class and the information regarding the content. As a result, the education-related institution or the education-related person can easily check the progress of the learning guidance by reading the report. In addition, there is an advantage that it is possible for a teacher to omit time and effort for creating a report.

### Example Embodiment 4

Example Embodiment 4 will be described with reference to FIG. 8. In Example Embodiment 4, a communication system including any of the information processing apparatuses 10, 20, and 30 according to Example Embodiments 1 to 3 will be described. In Example Embodiment 4, the same reference numerals are given to the components common to Example Embodiments 1 to 3, and the description thereof will be omitted.

(Communication System 1)

FIG. 8 is a diagram schematically illustrating an example of a configuration of a communication system 1 according to the present Example Embodiment 4. As illustrated in FIG. 8, the communication system 1 includes an information processing apparatus 10 (20, 30), a plurality of user terminals 100, and a management server 200. Here, the “information processing apparatus 10 (20, 30)” means any of the information processing apparatuses 10, 20, and 30 according to Example Embodiments 1 to 3 described above.

The plurality of user terminals 100 includes a first user terminal used by a teacher and a second user terminal used by each student. For example, each user terminal 100 is a personal computer or a tablet terminal.

The plurality of user terminals 100 and the information processing apparatus 10 (20, 30) are communicably connected via a certain communication network. Various data are transmitted and received between each user terminal 100 and the information processing apparatus 10 (20, 30). In particular, the log information is transmitted from each user terminal 100 to the information processing apparatus 10 (20, 30).

The log information includes information indicating the content used in the user terminal 100. The log information may include at least one of an operation log, an authentication log, an access log, a communication log, a call log, and an event log.

The information processing apparatus 10 (20, 30) analyzes the log information received from each of the user terminals 100, thereby generating the information indicating the classification of the class and the information regarding the used content as described in Example Embodiments 1 to 3 described above. Then, the information processing apparatus 10 (20, 30) records the generated information in the management server 200.

As described in Example Embodiment 3, the information processing apparatus 10 (20, 30) may create a report (FIG. 7) including the information indicating the classification of the class and the information regarding the used content. The information processing apparatus 10 (20, 30) may store the created report data in the management server 200. As a result, the education-related institution or the education-related person can easily refer to or acquire the data of the report stored in the management server 200 by connecting to the network using the first user terminal 100.

For security, an access restriction may be set in the management server 200 in such a way that the second user terminal 100 used by the student cannot access the management server 200. This is because the possibility that a student can view a report related to another student should be prevented from protecting personal information and privacy. Since the report corresponds to confidential information on the school side, the student should not be able to refer to or acquire data of the report even if the report relates to him/her.

### Effects of Present Example Embodiment

According to the configuration of the present example embodiment, the collection unit 11 collects log information from the user terminal 100. The classification unit 12 classifies the class content on the basis of the log information. The extraction unit 13 extracts information indicating used content from the log information of the user terminal 100. The recording unit 14 records the information indicating the classification of the class and the information regarding the content. When deciding the next class content, the teacher can accurately remember the previous class content by checking the record. The teacher can share information on the class content and how to proceed with the class with another teacher. In this way, by providing a mechanism for facilitating the teacher to review the online class content and how to proceed with the class, it is possible to promote the online class while reducing the burden on the teacher.

(Regarding Hardware Configuration)

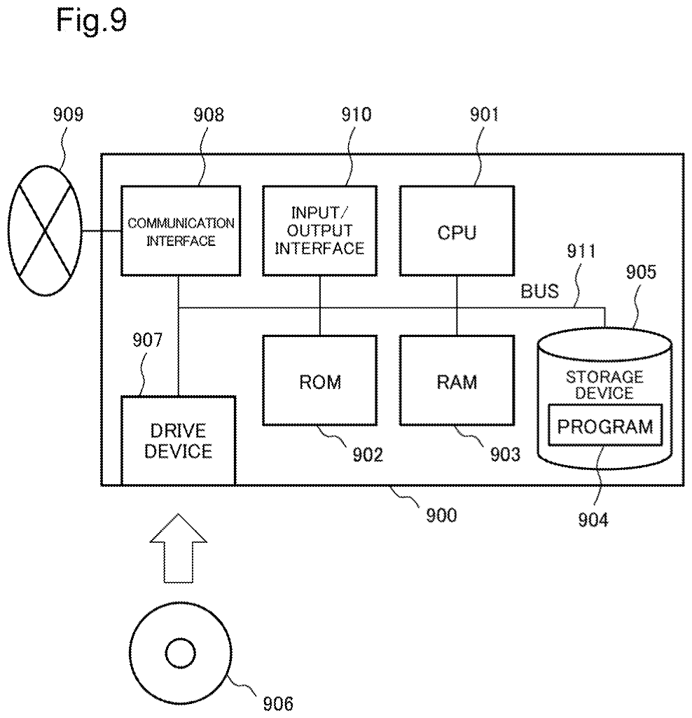

Each component of the information processing apparatuses 10, 20, and 30 described in Example Embodiments 1 to 3 indicates a block of a functional unit. Some or all of these components are implemented by the information processing apparatus 900 as illustrated in FIG. 9, for example. FIG. 9 is a block diagram illustrating an example of a hardware configuration of an information processing apparatus 900.

As illustrated in FIG. 9, the information processing apparatus 900 includes the following configuration as an example.
CPU (Central Processing Unit) 901
ROM (Read Only Memory) 902
RAM (Random Access Memory) 903
Program 904 loaded into RAM 903
Storage device 905 storing program 904
Drive device 907 that reads and writes recording medium 906
Communication interface 908 connected to communication network 909
Input/output interface 910 for inputting/outputting data
Bus 911 connecting each component

The components of the information processing apparatuses 10, 20, and 30 described in Example Embodiments 1 to 3 are implemented by the CPU 901 reading and executing the program 904 that implements these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the information processing apparatuses 10, 20, and 30 described in Example Embodiments 1 to 3 are achieved as hardware. Therefore, an effect similar to the effect described in any one Example Embodiments 1 to 3 can be obtained.

(Supplementary Notes)

One aspect of the present invention is also described as the following supplementary notes, but is not limited to the following.

(Supplementary Note 1)

An information processing apparatus including:

a collection means configured to collect log information from a user terminal;

a classification means configured to classify a class content, based on the log information;

an extraction means configured to extract information indicating a used content from the log information of the user terminal; and

a recording means configured to record information indicating a classification of the class and information regarding the used content.

(Supplementary Note 2)

The information processing apparatus according to Supplementary Note 1, in which

the classification means classifies the class content, based on keystroke data indicating an operation input amount to the user terminal.

(Supplementary Note 3)

The information processing apparatus according to Supplementary Note 2, in which

the classification means estimates the class content from first keystroke data extracted from log information of a first user terminal used by a teacher and second keystroke data extracted from log information of a second user terminal used by a student, and classifies the class content, based on a result of estimating the class content.

(Supplementary Note 4)

The information processing apparatus according to any one of Supplementary Notes 1 to 3, in which

the recording means records information indicating a classification of the class content and information regarding the used content for each time zone in which the classifications of the class content are same.

(Supplementary Note 5)

The information processing apparatus according to any one of Supplementary Notes 1 to 4, further including:

a creation means configured to create a report including information indicating a classification of the class and information regarding the used content.

(Supplementary Note 6)

An information processing method including:

collecting log information from a user terminal;

classifying a class content, based on the log information;

extracting information indicating a used content from the log information of the user terminal; and

recording information indicating a classification of the class and information regarding the used content.

(Supplementary Note 7)

A program for causing a computer to execute:

collecting log information from a user terminal;

classifying a class content, based on the log information;

extracting information indicating a used content from the log information of the user terminal; and

recording information indicating a classification of the class and information regarding the used content.

(Supplementary Note 8)

The information processing apparatus according to any one of Supplementary Notes 1 to 6, in which

the log information includes at least one of an operation log, an authentication log, an access log, a communication log, a call log, and an event log.

(Supplementary Note 9)

The information processing apparatus according to any one of Supplementary Notes 1 to 6, in which

the collection means collects an access log from the user terminal, and

the classification means classifies the class content, based on one or more of a domain name or a file name included in a URL of an access destination website from the user terminal, a page title, an HTML tag (for example, a title tag), and metadata.

(Supplementary Note 10)

The information processing apparatus according to any one of Supplementary Notes 1 to 6, in which

the collection means collects an access log from the user terminal, and

the classification means classifies the class content, based on one or more of contents and keywords of a web page specified by a URL of an access destination website from the user terminal or a document, an image, or a moving image linked to the web page.

(Supplementary Note 11)

The information processing apparatus according to any one of Supplementary Notes 1 to 6, in which

the collection means collects an operation log from the user terminal, and

the classification means classifies the class content, based on a content of an application (including a web application) activated by the user terminal or a learning subject related to the application.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing apparatus comprising:
a memory configured to store instructions; and
at least one processor configured to execute the instructions to perform:
collecting log information from a user terminal;
classifying a class content, based on the log information;
extracting information indicating a used content from the log information of the user terminal; and
recording information indicating a classification of the class and information regarding the used content.

2. The information processing apparatus according to claim 1, wherein
the at least one processor is configured to execute the instructions to perform:
classifying the class content, based on keystroke data indicating an operation input amount to the user terminal.

3. The information processing apparatus according to claim 2, wherein
the at least one processor is configured to execute the instructions to perform:
estimating the class content from first keystroke data extracted from log information of a first user terminal used by a teacher and second keystroke data extracted from log information of a second user terminal used by a student, and classifying the class content, based on a result of estimating the class content.

4. The information processing apparatus according to claim 1, wherein
the at least one processor is configured to execute the instructions to perform:
recording information indicating a classification of the class content and information regarding the used content for each time zone in which the classifications of the class content are same.

5. The information processing apparatus according to claim 1, further comprising
the at least one processor is configured to execute the instructions to perform:
creating a report including the information indicating a classification of the class and the information regarding the used content.

6. An information processing method comprising:
collecting log information from a user terminal;
classifying a class content, based on the log information;
extracting information indicating a used content from the log information of the user terminal; and
recording information indicating a classification of the class and information regarding the used content.

7. A non-transitory recording medium storing a program for causing a computer to execute:
collecting log information from a user terminal;
classifying a class content, based on the log information;
extracting information indicating a used content from the log information of the user terminal; and
recording information indicating a classification of the class and information regarding the used content.
